(19) United States
(12) Patent Application Publication
(10) Pub. No.: US 2009/0165308 A1
(43) Pub. Date: Jul. 2, 2009

(54) Utility knife with folding mechanism

(75) Inventor: Lance Howard, Sunrise, FL (US)

Correspondence Address: Dan M. DeLa Rosa, Esq., 300 E 77th St., Suite 24C, New York, NY, 10075, US

(73) Assignee: Iron Bridge Tools (IBT) Holding, LLC

(21) Appl. No.: 12/005,522

(22) Filed: Dec. 27, 2007

(51) Int. Cl. B26B 1/02

(52) U.S. Cl. 30/153

(57) ABSTRACT

A utility knife with a folding mechanism is provided, and the knife comprises: a handle comprising at least two side walls forming an internal space; a blade holding compartment having at least one end pivotally connected to the handle, the blade holding compartment comprises at least two side walls forming an internal blade cavity for holding a blade, the blade holding compartment comprises at least one notch, at least a portion of the blade holding compartment is designed to be situated within the space of the handle during a folded position; and a folding lock and release device comprises at least one spring and at least one slideably movable locking mechanism, and the mechanism comprises at least one protrusion and at least one button for controlling movement of the mechanism, and the protrusion engaging the notch and the spring being in an extended position during an open, unfolded position, and the button is slideably moved in one direction to compress the spring and to disengage the protrusion from the notch to allow for movement of the blade holding compartment to the folded position.

### BACKGROUND OF THE INVENTION

1. Field of the Invention

This invention relates to a utility knife and more specifically, to a utility knife with a folding mechanism. The present invention provides for a folding utility knife which comprises: a handle having at least two side walls forming an internal space; an implement pivotally connected to the handle, the implement comprising at least one end with at least one notch, at least a portion of the implement is designed to be situated within the space of the handle during a folded position; and a folding lock and release device comprising at least one spring and at least one slideably movable locking mechanism, and the mechanism comprises at least one protrusion and at least one button for controlling movement of the mechanism. The protrusion engages the notch and the spring is in an extended position during an open, unfolded position. The button is slideably moved in one direction to compress the spring and to disengage the protrusion from the notch to allow for movement of the blade holding compartment to the folded position.

2. Description of the Related Art

There are various patents covering folding utility knife type devices. These folding knives use an old fulcrum mechanism which comprises an elongated bar situated within the knife handle as shown in U.S. Pat. No. 3,568,315 to Smith, U.S. Pat. No. 4,563,813 to Fortenberry, and U.S. Pat. No. 7,040,022 to Ping. The elongated bar has opposing ends, one end has a latch which contacts a notch on the blade during an extended use position and disengages with the notch during a folded non-use position. The opposing end of the elongated bar has a portion protruding from the handle and provides the user with access to the folding device. The user uses a downward motion to activate the device and causes an upward movement of the opposing end of the bar with the notch to thereby disengage the mechanism and allow the blade to fold.

There are also many patents covering folding utility knives that have blade holding compartments such as U.S. Pat. No. 6,688,003 to Scarla, U.S. Pat. No. 6,354,007 to Scarla, U.S. Pat. No. 6,968,622 to Ping, U.S. Pat. No. 7,007,392 to Ping, U.S. Pat. No. 7,040,022 to Ping and U.S. Pat. No. 7,134,207 to Ping.

The present invention provides for folding utility knives with a new and improved folding mechanism. The present invention overcomes numerous problems presented by the prior art.

### SUMMARY OF THE INVENTION

In one embodiment, the present invention provides for a folding utility knife, the knife comprises: a handle comprising at least two side walls forming an internal space; a blade holding compartment having at least one end pivotally connected to the handle, the blade holding compartment comprises at least two side walls forming an internal blade cavity for holding a blade, the blade holding compartment comprises at least one notch, at least a portion of the blade holding compartment is designed to be situated within the space of the handle during a folded position; and a folding lock and release device comprises at least one spring and at least one slideably movable locking mechanism, and the mechanism comprises at least one protrusion and at least one button for controlling movement of the mechanism, and the protrusion engaging the notch and the spring being in an extended position during an open, unfolded position, and the button is slideably moved in one direction to compress the spring and to disengage the protrusion from the notch to allow for movement of the blade holding compartment to the folded position.

In another embodiment, the blade holding compartment comprises at least one indentation, and the button is then slideably moved in an opposite direction to permit the engagement of the protrusion to the indentation to thereby allow at least a portion of the blade holding compartment to be situated within the space of the handle and lock the knife into the folded position. In yet another embodiment, the spring is in an extended position once the button is moved in the opposite direction.

In still another embodiment, the indentation of the blade holding compartment is situated adjacent the end of the blade holding compartment that is pivotally connected to the handle.

In still yet another embodiment, the handle comprises at least one side lock, and the button is then slideably moved in an opposite direction to thereby allow at least a portion of the blade holding compartment to be situated within the cavity of the handle and the side lock is activated to lock the knife into the folded position.

In a further embodiment, the notch is situated adjacent the end of the blade holding compartment pivotally connected to the handle. In another further embodiment, the handle comprises top and bottom ends and the blade holding compartment comprises top and bottom ends, and the top end of the handle is pivotally attached to the bottom end of the blade holding compartment.

In yet a further embodiment, the knife comprises an interchangeable blade having at least one side with a sharp edge for cutting, and at least a portion of the blade is situated within the blade cavity of the blade holding compartment and a portion of the blade is situated outside of the blade holding compartment to expose at least a portion of the sharp edge of the blade. In still a further embodiment, the knife comprises a device for securing the blade within the blade cavity of the blade holding compartment.

In yet a further embodiment, at least a portion of the folding lock and release device is situated within the space of the handle. In still yet a further embodiment, the knife comprises a support, and the spring has opposing ends, the first end of the spring has contact with the support and the second end of the spring has contact with at least a portion of the mechanism.

In another further embodiment, the button is slideably moved to compress the spring and held while the blade holding compartment is moved from a folded to an unfolded position. In still another further embodiment, the button is slideably moved to compress the spring and held while the blade holding compartment is moved from an unfolded to a folded position.

In yet another further embodiment, the handle comprises dividers situated in between the side walls, and the dividers provide for compartments for implements. In still yet another further embodiment, the implements are selected from a group consisting essentially of blades, scissors, screwdrivers, nail cutters, cutting devices, trimming devices and grooming devices.

In another further embodiment, the present invention provides for a utility knife with a folding mechanism, the knife comprises: a handle pivotally connected to a blade holding compartment, the handle comprises top and bottom ends and at least two side walls forming an internal cavity, the cavity of the handle is designed to encase at least a portion of the blade holding compartment during a folded position, the blade holding compartment comprises top and bottom ends and at least two side walls forming an internal blade cavity for holding a blade, and the bottom end of the blade holding compartment comprises at least one notch and at least one indentation; and a folding lock and release device comprising at least one spring and at least one slideably movable locking mechanism, and the mechanism comprises at least one protrusion and at least one button for controlling movement of the mechanism, and the protrusion engages the indentation and the spring is in an extended position during the folded position, and the button is slideably moved in one direction to compress the spring and to disengage the protrusion from the indentation to allow for movement of the blade holding compartment to an open, unfolded position, and the button is then slideably moved in an opposite direction to allow engagement of the protrusion to the notch to thereby lock the blade holding compartment into an open, unfolded position.

In still another embodiment, the present invention relates to a folding utility knife, the knife comprises: a handle comprising at least two side walls forming an internal space; an implement pivotally connected to the handle, the implement comprises at least one end with at least one notch, at least a portion of the implement is designed to be situated within the space of the handle during a folded position; and a folding lock and release device comprising at least one spring and at least one slideably movable locking mechanism, and the mechanism comprises at least one protrusion and at least one button for controlling movement of the mechanism, and the protrusion engaging the notch and the spring is in an extended position during an open, unfolded position, and the button is slideably moved in one direction to compress the spring and to disengage the protrusion from the notch to allow for movement of the blade holding compartment to the folded position.

In yet another embodiment, the handle comprises a channel, and the spring is situated within the channel.

For purposes of this invention, the term “implement” shall mean any and all devices that can be pivotally attached to a folding knife and then be unfolded and folded to allow at least a portion of the implement to be situated within the space of the handle of the knife.

In a further embodiment, the blade holding compartment comprises at least one indentation, and the button is then slideably moved in an opposite direction to permit the engagement of the protrusion to the indentation to thereby allow at least a portion of the blade holding compartment to be situated within the space of the handle and lock the knife into the folded position.

In another further embodiment, the handle comprises at least one side lock, and the button is then slideably moved in an opposite direction to thereby allow at least a portion of the blade holding compartment to be situated within the cavity of the handle and the side lock is activated to lock the knife into the folded position.

In another embodiment, the present invention relates to a folding utility knife. The knife comprises: a handle pivotally connected to a blade holder, the handle comprising top and bottom ends and at least two side walls forming an internal cavity, and the cavity forms at least two compartments. The first compartment of the cavity of the handle is designed to encase at least a portion of the blade holding compartment during a folded position. The blade holder comprises top and bottom ends and at least two side walls forming an internal blade cavity for holding a blade. The bottom end of the blade holder comprises at least one notch and at least one indentation.

The knife further comprises a folding lock and release device, the device comprises at least one spring and at least one slideably movable locking mechanism. The mechanism comprises at least one protrusion and at least one button for controlling movement of the mechanism. The protrusion engaging the indentation and the spring is in an extended position during a first open, unfolded position. The button is slideably moved in one direction to compress the spring and allow disengagement of the protrusion from the notch to allow for movement of the blade holder to a folded position. The button is then slideably moved in an opposite direction to allow engagement of the protrusion to the indentation to thereby allow at least a portion of the blade holder to be situated within the cavity of the handle into a closed, folded position.

The knife also comprises a foldable knife pivotally attached to the handle, and at least a portion of the knife is designed to be encased within the second compartment of the cavity of the handle during a closed, folded position.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIGS. 1a-c are perspective views of the folding utility knife of the present invention showing how the folding blade holding compartment goes from an open position to a closed position;

FIGS. 2a-c are perspective views showing how the folding blade holding compartment goes from a closed position to an open position;

FIG. 3 is a cutaway view of the folding mechanism of the present invention in an open, unfolded position;

FIG. 4 is a cutaway view of FIG. 3 showing the folding movement of the blade holding compartment;

FIG. 5 is a cutaway view of FIG. 4 showing the blade holding compartment in a closed, folded position; and

FIG. 6 is a perspective view of another embodiment of the invention showing a folding blade holding compartment and a folding knife.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

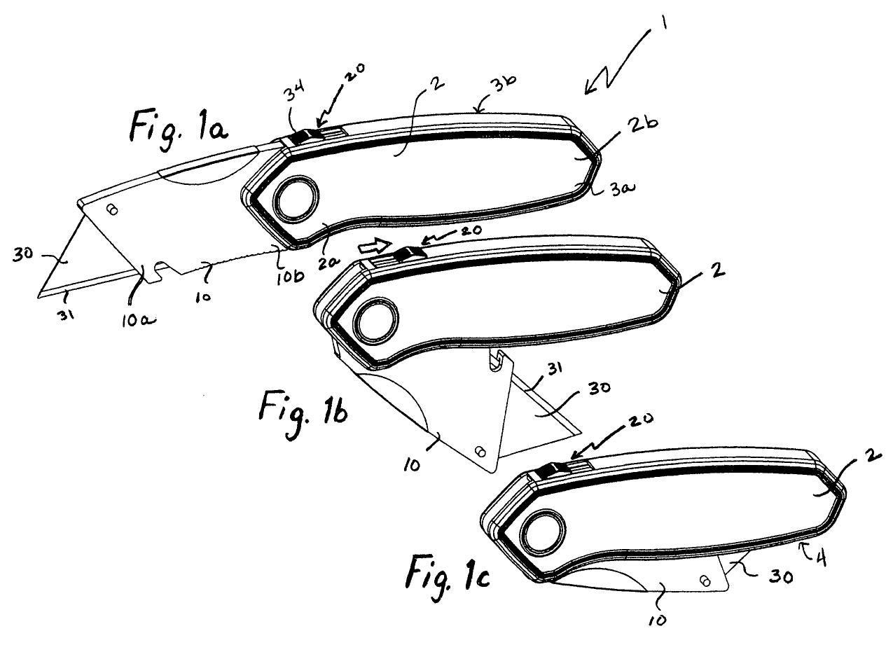

FIGS. 1a-c illustrate a folding utility knife 1 going from an open position to a closed position. The knife 1 comprises: a handle 2, a blade holding compartment 10 and folding lock and release device 20. The handle 2 has at least two side walls, 3a and b respectively, and the side walls 3a-b form an internal space 4 (not shown).

The blade holding compartment 10 has at least one end pivotally connected to the handle 2. The blade holding compartment 10 comprises at least two side walls 13a and b respectively, and the side walls 13a-b form an internal blade cavity 14 for holding a blade 30. The blade holding compartment 10 comprises at least one notch 15 (not shown), and at least a portion of the blade holding compartment 10 is designed to be situated within the space 4 of the handle 3 during a folded position (as shown in FIG. 1c).

The folding lock and release device 30 comprises at least one spring 31 (not shown) and at least one slideably movable locking mechanism 32. The mechanism 32 comprises at least one protrusion 33 (not shown) and at least one button 34 for controlling movement of the mechanism 32. The protrusion 33 engages the notch 15 and the spring 31 in an extended position during an open, unfolded position (as shown in FIG. 1a). The button 34 is slideably moved in one direction to compress the spring 31 and to disengage the protrusion 33 from the notch 15 to allow for movement of the blade holding compartment to the folded position (as shown in FIG. 1b).

The blade holding compartment 10 may also comprises at least one indentation 16 (not shown), and the button 34 is then slideably moved in an opposite direction to permit the engagement of the protrusion 33 to the indentation 16 to thereby allow at least a portion of the blade holding compartment 10 to be situated within the space 4 of the handle 2 and lock the knife 1 into the folded position (as shown in FIG. 1c).

The handle 2 comprises top and bottom ends, 2a and b respectively, and the blade holding compartment 10 comprises top and bottom ends, 10a and b respectively. The top end 2a of the handle 2 is pivotally attached to the bottom end 10b of the blade holding compartment 10.

The knife 1 further comprises an interchangeable blade 30 having at least one side with a sharp edge 31 for cutting, and at least a portion of the blade is situated within the blade cavity 14 of the blade holding compartment 10 and a portion of the blade 30 is situated outside of the blade holding compartment 10 to expose at least a portion of the sharp edge 31 of the blade 30. The knife 1 further comprises a device 40 (not shown) for securing the blade 30 within the blade cavity 14 of the blade holding compartment 10.

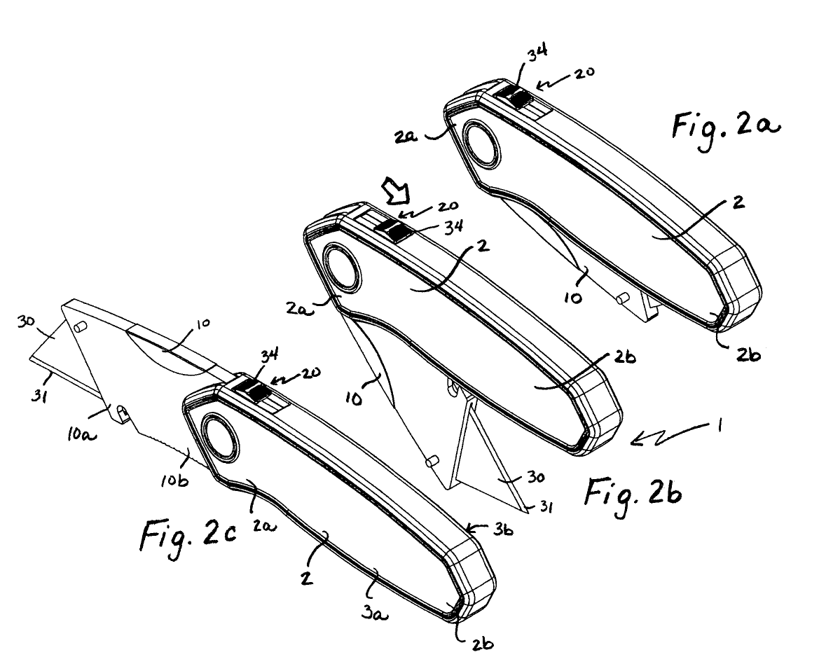

FIGS. 2a-c illustrates an utility knife 1 with a folding mechanism going from a closed position to an open position. The knife 1 comprises: a handle 2 pivotally connected to a blade holding compartment 10. The handle 2 comprises top and bottom ends, 2a and b respectively, and at least two side walls, 3a and b, forming an internal cavity 4 (not shown). The cavity 4 of the handle 2 is designed to encase at least a portion of the blade holding compartment 10 during a folded position (as shown in FIG. 2a).

The blade holding compartment 10 comprises top and bottom ends, 10a-b, and at least two side walls, 13a and b, forming an internal blade cavity 14 for holding a blade 30. The bottom end 10b of the blade holding compartment 10 comprises at least one notch 15 (not shown) and at least one indentation 16 (not shown). The knife further comprises a folding lock and release device 20 which has at least one spring 31 (not shown) and at least one slideably movable locking mechanism 32. The mechanism 32 comprises at least one protrusion 33 (not shown) and at least one button 34 for controlling movement of the mechanism 32. The protrusion 33 engages the indentation 16 and the spring 31 is in an extended position during the folded position (as shown in FIG. 2a). The button 34 is slideably moved in one direction to compress the spring 31 and to disengage the protrusion 33 from the indentation 16 to allow for movement of the blade holding compartment 10 to an open, unfolded position (as shown in FIG. 2b). The button 34 is then slideably moved in an opposite direction to allow engagement of the protrusion 33 to the notch 15 to thereby lock the blade holding compartment 10 into an open, unfolded position (as shown in FIG. 2c). The button 34 is slideably moved to compress the spring 31 and held while the blade holding compartment 10 is moved from a folded to an unfolded position.

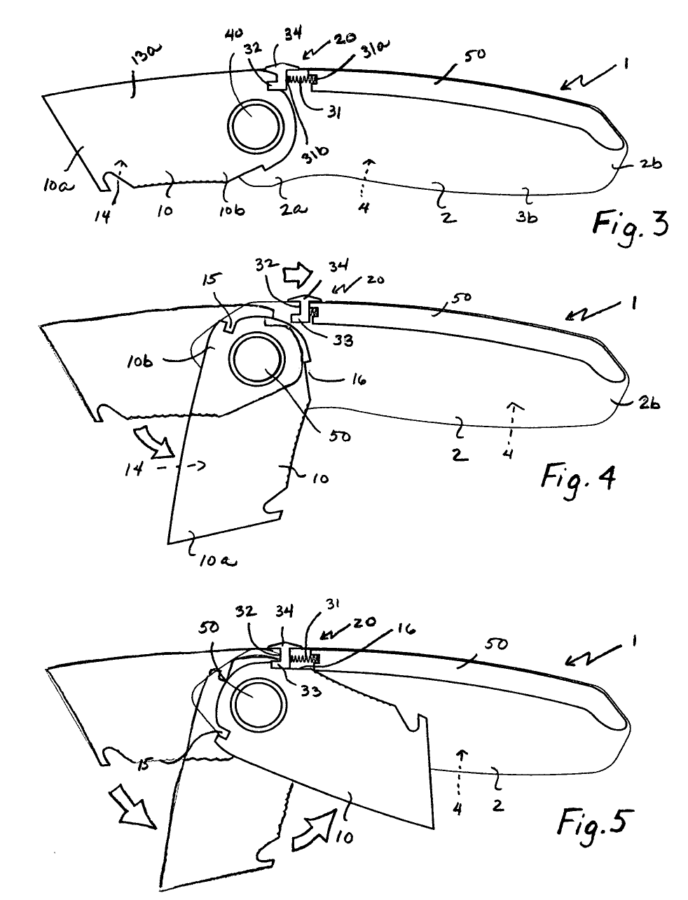

FIGS. 3-5 relate to cutaway views of the folding knife 1 of the present invention. The knife 1 comprises: a handle 2, a blade holding compartment 10 and folding lock and release device 20. The handle 2 has at least two side walls, 3a (not shown) and 3b, and the side walls 3a-b form an internal space 4.

The blade holding compartment 10 has at least one end pivotally connected to the handle 2 at a pivot point 40. The blade holding compartment 10 comprises at least two side walls 13a and 13b, and the side walls 13a-b form an internal blade cavity 14 for holding a blade 30 (not shown). The blade holding compartment 10 comprises at least one notch 15, and at least a portion of the blade holding compartment 10 is designed to be situated within the space 4 of the handle 3 during a folded position (as shown in FIG. 5).

The folding lock and release device 30 comprises at least one spring 31 and at least one slideably movable locking mechanism 32. The mechanism 32 comprises at least one protrusion 33 and at least one button 34 for controlling movement of the mechanism 32. The protrusion 33 engages the notch 15 and the spring 31 in an extended position during an open, unfolded position (as shown in FIG. 3). The button 34 is slideably moved in one direction to compress the spring 31 and to disengage the protrusion 33 from the notch 15 to allow for movement of the blade holding compartment to the folded position (as shown in FIG. 4).

The blade holding compartment 10 further comprises at least one indentation 16, and the button 34 is then slideably moved in an opposite direction to permit the engagement of the protrusion 33 to the indentation 16 to thereby allow at least a portion of the blade holding compartment 10 to be situated within the space 4 of the handle 2 and lock the knife 1 into the folded position (as shown in FIG. 5). The spring 31 is in an extended position once the button 34 is moved in the opposite direction.

The handle 2 comprises top and bottom ends, 2a and b respectively, and the blade holding compartment 10 comprises top and bottom ends, 10a and b respectively. The top end 2a of the handle 2 is pivotally attached to the bottom end 10b of the blade holding compartment 10.

At least a portion of the folding lock and release device 20 is situated within the space 4 of the handle 2. The knife 1 further comprises a support 50, and the spring 31 has opposing ends, 31a and 31b respectively, the first end 31a of the spring 31 has contact with the support 50 and the second end 31b of the spring 31 has contact with at least a portion of the mechanism 32.

In one embodiment, the button 34 is slideably moved to compress the spring 31 and held while the blade holding compartment 10 is moved from a folded to an unfolded position. In another embodiment, the button 34 is slideably moved to compress the spring 31 and held while the blade holding compartment 10 is moved from an unfolded to a folded position.

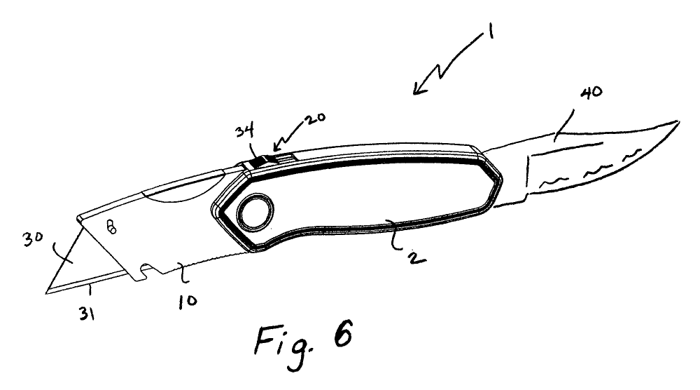

FIG. 6 illustrates another embodiment of the present invention. In this further embodiment, the knife 1 comprises: a handle 2 pivotally connected to a blade holder 10, the handle 2 comprising top and bottom ends, 2a and b, and at least two side walls, 3a and b, forming an internal cavity 4. The cavity 4 forms at least two compartments, 8 and 9 respectively (not shown). The first compartment 8 of the cavity 4 of the handle 2 is designed to encase at least a portion of the blade holding compartment 10 during a folded position. The blade holder 10 comprises top and bottom ends, 10a and b, and at least two side walls, 13a and b, forming an internal blade cavity 14 for holding a blade 30. The bottom end 10b of the blade holder comprises at least one notch 15 (not shown) and at least one indentation 16 (not shown).

The knife further comprises a folding lock and release device 20. The device 20 comprises at least one spring 31 (not shown) and at least one slideably movable locking mechanism 32. The mechanism 32 comprises at least one protrusion 33 (not shown) and at least one button 34 for controlling movement of the mechanism 32. The protrusion 33 engages the indentation 16 and the spring 31 is in an extended position during a first open, unfolded position. The button 34 is slideably moved in one direction to compress the spring 31 and allow disengagement of the protrusion 33 from the notch 15 to allow for movement of the blade holder 10 to a folded position. The button 34 is then slideably moved in an opposite direction to allow engagement of the protrusion 33 to the indentation 16 to thereby allow at least a portion of the blade holder 10 to be situated within the cavity 4 of the handle 2 into a closed, folded position.

The knife 1 also comprises a foldable knife 40 pivotally attached to the handle 2, and at least a portion of the knife 40 is designed to be encased within the second compartment 9 of the cavity 4 of the handle 2 during a closed, folded position.

In one embodiment, the knife 40 is pivotally connected to the bottom end 2b of the handle 2. In another embodiment, the knife 40 is pivotally connected to the top end 2a of the handle 2 (not shown). The folding knife or other implements may be on the same side or on opposite sides of the blade holding compartment or blade holder relative to its pivotal connection on the handle.

The knife 1 may also have separate compartments for encasing the blade holding compartment 10 and the knife 40 and other implements. The compartments are created with dividers situated within the space 4 of the handle 2.

In another embodiment, the bottom end of the blade holding compartment 10 will have the protrusion and the folding lock and release device 20 will have a notch for receiving the protrusion of the blade holding compartment. This invention also relates to other mechanisms for engaging and disengaging the blade holding compartment with a folding lock and release device to allow for the folding and unfolding of the blade holder, knifes, and other implements.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A folding utility knife comprising:
a handle comprising at least two side walls forming an internal space;
a blade holding compartment having at least one end pivotally connected to said handle, said blade holding compartment comprising at least two side walls forming an internal blade cavity for holding a blade, said blade holding compartment comprises at least one notch, at least a portion of said blade holding compartment is designed to be situated within said space of said handle during a folded position; and
a folding lock and release device comprising at least one spring and at least one slideably movable locking mechanism, said mechanism comprising at least one protrusion and at least one button for controlling movement of said mechanism, said protrusion engaging said notch and said spring being in an extended position during an open, unfolded position, said button is slideably moved in one direction to compress said spring and to disengage said protrusion from said notch to allow for movement of said blade holding compartment to said folded position.

2. The knife of claim 1 wherein said blade holding compartment comprises at least one indentation, said button is then slideably moved in an opposite direction to permit the engagement of said protrusion to said indentation to thereby allow at least a portion of said blade holding compartment to be situated within said space of said handle and lock said knife into said folded position.

3. The knife of claim 2 wherein said spring is in an extended position once said button is moved in said opposite direction.

4. The knife of claim 2 wherein said indentation is situated adjacent said end of said blade holding compartment that is pivotally connected to said handle.

5. The knife of claim 1 wherein said handle comprises at least one side lock, said button is then slideably moved in an opposite direction to thereby allow at least a portion of said blade holding compartment to be situated within said cavity of said handle and said side lock is activated to lock said knife into said folded position.

6. The knife of claim 1 wherein said notch is situated adjacent said end of said blade holding compartment pivotally connected to said handle.

7. The knife of claim 3 wherein said handle comprises top and bottom ends and said blade holding compartment comprises top and bottom ends, said top end of said handle is pivotally attached to said bottom end of said blade holding compartment.

8. The knife of claim 1 further comprising an interchangeable blade having at least one side with a sharp edge for cutting, at least a portion of said blade being situated within said blade cavity of said blade holding compartment and a portion of the blade being situated outside of the blade holding compartment to expose at least a portion of the sharp edge of said blade.

9. The knife of claim 1 further comprising a device for securing the blade within said blade cavity of said blade holding compartment.

10. The knife of claim 1 wherein at least a portion of said folding lock and release device is situated within said space of said handle.

11. The knife of claim 1 further comprises a support, said spring having opposing ends, said first end of said spring having contact with said support and said second end of said spring having contact with at least a portion of said mechanism.

12. The knife of claim 1 wherein said button is slideably moved to compress said spring and held while said blade holding compartment is moved from a folded to an unfolded position.

13. The knife of claim 1 wherein said button is slideably moved to compress said spring and held while said blade holding compartment is moved from an unfolded to a folded position.

14. The knife of claim 1 wherein said handle further comprises dividers situated in between said side walls, said dividers provide for compartments for implements.

15. The knife of claim 1 wherein said implements are selected from a group consisting essentially of blades, scissors, screwdrivers, nail cutters, cutting devices, trimming devices and grooming devices.

16. A folding utility knife comprising:
a handle pivotally connected to a blade holding compartment, said handle comprising top and bottom ends and at least two side walls forming an internal cavity, said cavity of said handle designed to encase at least a portion of said blade holding compartment during a folded position, said blade holding compartment comprising top and bottom ends and at least two side walls forming an internal blade cavity for holding a blade, said bottom end of said blade holding compartment comprising at least one notch and at least one indentation; and
a folding lock and release device comprising at least one spring and at least one slideably movable locking mechanism, said mechanism comprises at least one protrusion and at least one button for controlling movement of said mechanism, said protrusion engaging said indentation and said spring being in an extended position during said folded position, said button is slideably moved in one direction to compress said spring and to disengage said protrusion from said indentation to allow for movement of said blade holding compartment to an open, unfolded position, said button is then slideably moved in an opposite direction to allow engagement of said protrusion to said notch to thereby lock said blade holding compartment into an open, unfolded position.

17. The knife of claim 16 further comprises a support, said spring having opposing ends, said first end of said spring having contact with said support and said second end of said spring having contact with at least a portion of said mechanism.

18. The knife of claim 16 further comprising an interchangeable blade having at least one side with a sharp edge for cutting, at least a portion of said blade being situated within said blade cavity of said blade holding compartment and a portion of the blade being situated outside of the blade holding compartment to expose at least a portion of the sharp edge of said blade.

19. The knife of claim 16 further comprising a device for securing the blade with said blade cavity of said blade holding compartment.

20. The knife of claim 16 wherein said button is slideably moved to compress said spring and held while said blade holding compartment is moved from a folded to an unfolded position.

21. The knife of claim 16 wherein said button is slideably moved to compress said spring and held while said blade holding compartment is moved from an unfolded to a folded position.

22. The knife of claim 16 wherein said folding lock and release device is situated adjacent said top end of said handle.

23. The knife of claim 16 wherein said button of said mechanism contacts said blade holding compartment during said unfolded position.

24. The knife of claim 16 wherein said handle further comprises dividers situated in between said side walls, said dividers provide for compartments for implements.

25. The knife of claim 24 wherein said implements are selected from a group consisting essentially of blades, scissors, screwdrivers, nail cutters, cutting devices, trimming devices and grooming devices.

26. A folding utility knife comprising:
a handle pivotally connected to a blade holder, said handle comprising top and bottom ends and at least two side walls forming an internal cavity, said cavity forming at least two compartments, said first compartment of said cavity of said handle designed to encase at least a portion of said blade holding compartment during a folded position, said blade holder comprising top and bottom ends and at least two side walls forming an internal blade cavity for holding a blade, said bottom end of said blade holder comprising at least one notch and at least one indentation;
a folding lock and release device comprising at least one spring and at least one slideably movable locking mechanism, said mechanism comprising at least one protrusion and at least one button for controlling movement of said mechanism, said protrusion engaging said indentation and said spring being in an extended position during a first open, unfolded position, said button is slideably moved in one direction to compress said spring and allow disengagement of said protrusion from said notch to allow for movement of said blade holder to a folded position, said button is then slideably moved in an opposite direction to allow engagement of said protrusion to said indentation to thereby allow at least a portion of said blade holder to be situated within said cavity of said handle into a closed, folded position; and
a foldable knife pivotally attached to said handle, at least a portion of said knife designed to be encased within said second compartment of said cavity of said handle during a closed, folded position.

27. A folding utility knife comprising:
a handle comprising at least two side walls forming an internal space;
a implement pivotally connected to said handle, said implement comprising at least one end with at least one notch, at least a portion of said implement designed to be situated within said space of said handle during a folded position; and
a folding lock and release device comprising at least one spring and at least one slideably movable locking mechanism, said mechanism comprising at least one protrusion and at least one button for controlling movement of said mechanism, said protrusion engaging said notch and said spring being in an extended position during an open, unfolded position, said button is slideably moved in one direction to compress said spring and to disengage said protrusion from said notch to allow for movement of said blade holding compartment to said folded position.

28. The knife of claim 27 wherein said implements are selected from a group consisting essentially of blades, scissors, screwdrivers, blade holding compartments, nail cutters cutting devices, trimming devices and grooming devices.

29. The knife of claim 27 wherein said handle comprises a channel, said spring being situated within said channel.

30. The knife of claim 27 wherein said blade holding compartment comprises at least one indentation, said button is then slideably moved in an opposite direction to permit the engagement of said protrusion to said indentation to thereby allow at least a portion of said blade holding compartment to be situated within said space of said handle and lock said knife into said folded position.

31. The knife of claim 27 wherein said handle comprises at least one side lock, said button is then slideably moved in an opposite direction to thereby allow at least a portion of said blade holding compartment to be situated within said cavity of said handle and said side lock is activated to lock said knife into said folded position.
